(19) United States
(12) Patent Application Publication
(10) Pub. No.: US 2020/0232273 A1
(43) Pub. Date: Jul. 23, 2020

(54) REMOVABLE MESH SCREEN FOR A DOOR GATE

(71) Applicant: Kidco, Inc., Libertyville, IL (US)

(72) Inventors: Daniel Kaiser, Chicago, IL (US); Zhe Shen, Palatine, IL (US)

(73) Assignee: Kidco, Inc., Libertyville, IL (US)

(21) Appl. No.: 16/250,528

(22) Filed: Jan. 17, 2019

(51) Int. Cl. E06B 9/52; E06B 9/02

(52) U.S. Cl. CPC E06B 9/52; E06B 2009/002; E06B 9/02

(57) ABSTRACT

A gate for restricting access to and from an area includes a first post, a second post, a floor support member, and a gate door. The gate door includes a rigid frame and a mesh screen, the mesh screen including at least one panel adjacent a mesh portion of the mesh screen and at least one flap, the flap substantially encasing a portion of the frame and being configured to overlap the at least one panel. The gate door further includes an opening in at least one of the panel and flap and a screw socket having a socket portion fixedly coupled to either the flap or the overlapping panel, the screw socket further comprising a screw portion configured to pass through the opening and to couple to the socket portion. In addition, the gate includes a hook and loop fastener connection between the flap and the overlapping panel

### BACKGROUND

### Field of the Disclosure

The present invention relates to a removable mesh screen for a gate.

### Description of the Background of the Disclosure

In the field of safety gates, adjustable gates configured to fit within a conventional door frame are a popular and effective means of preventing children or pets from entering certain areas. Such areas may contain, for example, potentially hazardous or breakable items that parents and homeowners desire to restrict from children or pet interaction.

In prior art gates, as shown in FIG. 1, closely-spaced, vertical bars are attached to a supporting structure, and the supporting structure may adjust to the width of the door frame. These vertical bars may be made of metal or wood. Such vertical bars are often permanently attached to the supporting structure of the gate. For example, vertical bars made of metal may be welded to a metal support structure. Alternatively, vertical bars made of wood may be fastened to a wooden support structure.

However, the use of vertical bars is costly and inconvenient to both the manufacturer and the user. Skilled laborers or expensive machines are used to perform the welding or fastening procedures. Also, since the vertical bars are thin, a plurality of them must be used to serve as a sufficient barrier to prevent children or pets from squeezing through. This plurality of vertical bars increases the overall weight and manufacturing time of the structure. Further, the stiffness of metal or wooden vertical bars may cause injury to a child or pet who may, for example, run into the barrier head-first.

As a result, in one instance, mesh screens have been used in lieu of the vertical bars. Mesh screens are made of fabric materials, which may include nylon or some other material or combination of suitable materials. Instead of welding or complex fastening, the mesh screens may be fastened by sewing the fabric to itself once it is stretched around portions of the supporting structure. Since mesh fabric is often lighter than metal or wood, the overall weight of the safety gate is reduced. Further, the mesh screen may stretch and flex during use, due to its material properties and fastening techniques. This flexibility allows the children or pets interacting with the barrier to experience a reduced impact force, should they run into the gate during use.

Yet, mesh screens can become dirty and unsightly more easily than vertical bars. Like clothing, the fabric of mesh screens may become stained or soiled through interaction with children, pets, or during transportation installation. Indeed, users desire to present a home that is clean and void of unsightly stains. Since prior art mesh screens are sewn around the portions of the supporting structure, a user must either clean the mesh screen while placed within the doorway or remove the entire gate in order to access a suitable place for cleaning.

Therefore, what is needed is a gate that addresses one or more of the drawbacks of existing gates.

### SUMMARY

In one aspect, a gate for restricting access to and from an area includes a first post, a second post, a floor support member, a plurality of lateral threaded members, a gate door, and a latch, where the gate door includes a handle, a pair of vertical rods, a pair of horizontal rods, and a mesh screen. The mesh screen is removably attached to the vertical rods and the horizontal rods, and the gate is configured to be installed between external supports by engaging the plurality of lateral threaded members with the external supports. The mesh screen includes at least one flap substantially encasing at least one of the vertical rods or horizontal rods, the at least one flap configured to overlap a respective panel adjacent a mesh portion of the mesh screen. The gate also includes an opening in at least one of the flap and panel and a screw socket having a socket portion fixedly coupled to at least one of the flap and panel, the screw socket further comprising a screw portion configured to pass through the opening and to couple to the socket portion. Additionally, the gate includes a hook and loop fastener connection between the flap and panel.

In another aspect, a gate for restricting access to and from an area includes a first post, a second post, a floor support member, and a gate door. The gate door includes a rigid frame and a mesh screen, the mesh screen including at least one panel adjacent a mesh portion of the mesh screen and at least one flap, the flap substantially encasing a portion of the frame and being configured to overlap the at least one panel. The gate door further includes an opening in at least one of the panel and flap and a screw socket having a socket portion fixedly coupled to either the flap or the overlapping panel, the screw socket further comprising a screw portion configured to pass through the opening and to couple to the socket portion. In addition, the gate includes a hook and loop fastener connection between the flap and the overlapping panel.

### DESCRIPTION OF THE DRAWINGS

FIG. 1 is a perspective view of a top, front, and side of a prior art gate with closely-spaced vertical bars;

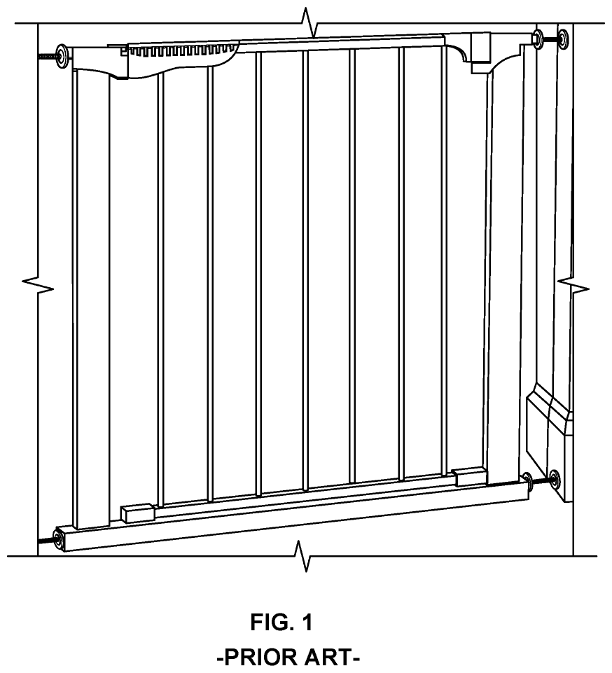

FIG. 2 is a rear elevational view of a gate installed between external supports;

FIG. 3 is a rear, partially exploded, elevational view of a gate;

FIG. 4A is a front and top isometric view of a gate uninstalled, wherein the gate door is in an open position;

FIG. 4B is a perspective view of a top, side, and rear of a portion of a gate;

FIG. 5 is a rear elevational view of an unfastened portion of a mesh screen for a gate;

FIG. 6 is a perspective view of a bottom and side of fasteners for a gate; and

FIG. 7 is a perspective view of a top and side of fasteners for a gate.

### DETAILED DESCRIPTION

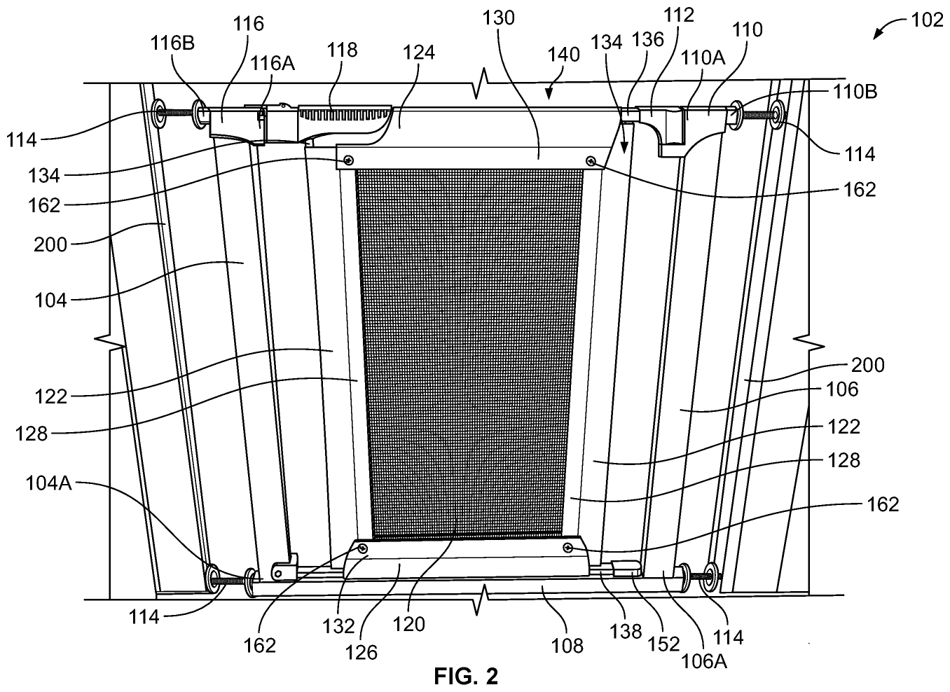

Referring to FIG. 2, a gate 102 is installed between external supports 200. The external supports 200 are typically made of construction materials, e.g., wood, drywall, concrete, etc. Further, the external supports 200 may be adjacent any means of egress where a user may desire access to be restricted, e.g., a doorway, hallway, stairway, etc. A first post 104 and a second post 106 are disposed at the outermost sides of the gate 102. The first and second posts 104, 106 each have a lower end 104A, 106A attached to a floor support member 108 disposed horizontally at the bottom of the gate 102. The first and second posts 104, 106 attach to the floor support member 108 to form a stationary, “U”-shaped outer frame. In the present embodiment, the first and second posts 104, 106 are permanently attached to the floor support member by welding, although other attachment means may be contemplated, such as using fasteners, adhesives, or friction fittings.

In some aspects, the gate 102 may be combined with multiple barrier portions, e.g., fence portions, to form an extended barrier capable of being configured for restricting access from areas. For example, a gate 102 and one or more barrier portions may be combined to surround stairway landings, double-doors, or even to form a self-contained area encircled only by the gate 102 and barrier portion(s).

Still referring to FIG. 2, an upper hinge shoulder 110 is disposed atop the second post 106, opposite the lower end 106A. The upper hinge shoulder 110 is configured to receive a hinge arm 112 of a swinging portion of the gate 102 at a first side 110A and a threaded member 114 at a second side 110B. The upper hinge shoulder 110 is permanently attached to the second post 106, although removable attachment means are contemplated. An upper latch 116 is disposed atop the first post 104 opposite the lower end 104A. The upper latch 116 is configured to receive a handle 118 at a first side 116A and a threaded member 114 at a second side 116B. The upper latch 116 is permanently attached to the first post 104, although removable fastening means are contemplated.

It is contemplated that the first and second posts 104, 106 may have a fixed height, equal to the height of the gate 102. More preferentially, the first and second posts 104, 106 could have a height between about 23″ and about 30″ in order to prevent young children and pets from traversing the gate 102. With reference to FIG. 2, the external supports 200 may have a width between them of between about 29″ and about 37″. Accordingly, the gate 102 is configured to permit the first and second posts 104, 106 to fit between the external supports 200, e.g., between a residential door frame, while at the same time establishing narrow openings between the first and second posts 104, 106 and their respective external supports 200.

With reference to FIG. 2, a gate door 140 is depicted including a mesh screen 120. The mesh screen 120 is disposed between the first and second posts 104, 106 and above the floor support member 108, within the “U” frame. Also, the mesh screen 120 is attached to fabric side panels 122, an upper panel 124, and a lower panel 126. When installed, the side panels 122 extend parallel to the first and second posts 104, 106 while the upper panel 124 and lower panel 126 extend parallel to the floor support member 108. Each side panel 122 includes a side panel flap 128 extending along a substantial portion of its elongate direction. The upper panel 124 includes an upper panel flap 130 extending along a substantial portion of its elongate direction. Likewise, the lower panel 126 includes a lower panel flap 132 extending along a substantial portion of its elongate direction.

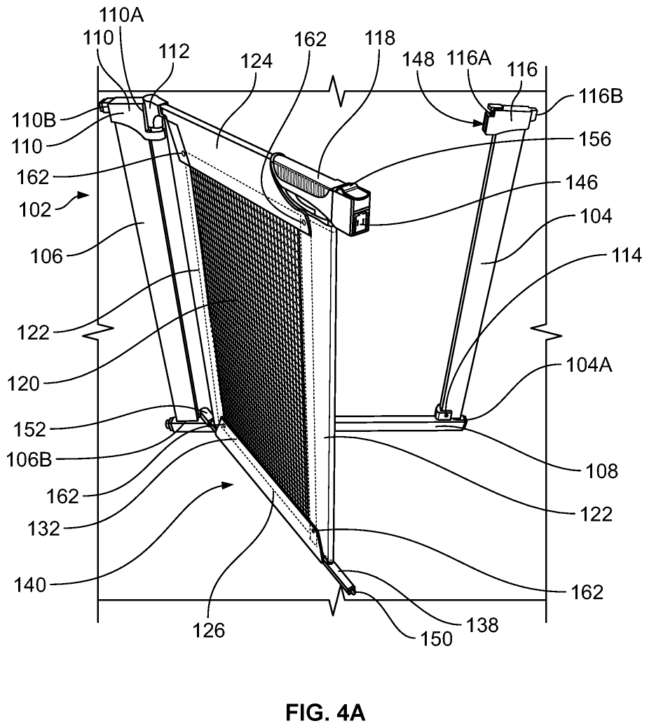

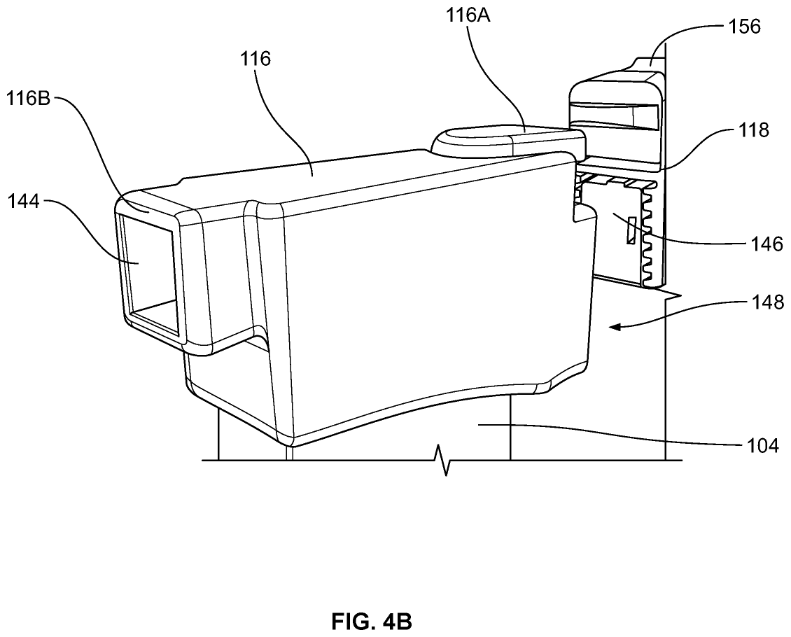

Still referring to FIG. 2, the side panels 122 are wrapped around vertical rods 134, and extend between the upper rod 136 and the lower rod 138. The upper panel 124 is wrapped around the upper rod 136 and the lower panel 126 is wrapped around the lower rod 138. Further, the upper rod 136 includes or is coupled to the handle 118 at one end and the hinge arm 112 at an opposing end. The lower rod 138 includes a plunger 150 (see FIG. 4A) at one end, i.e., the end above the handle 118, and a locator 152 at an opposing end.

In one aspect, the safety gate 102 has adjustable threaded members 114 protruding laterally from the supporting structure, as shown in FIGS. 2 and 4. In those figures, threaded members 114 protrude from both ends of the floor support member 108, adjacent lower ends 104A, 106A of the first and second posts 104, 106. Also, a threaded member 114 protrudes from the second side 110B of the upper hinge shoulder 110, and another threaded member 114 protrudes from the second side 116B of the upper latch 116. Each of the threaded members 114 interacts with external supports 200 to fix the gate 102 in place.

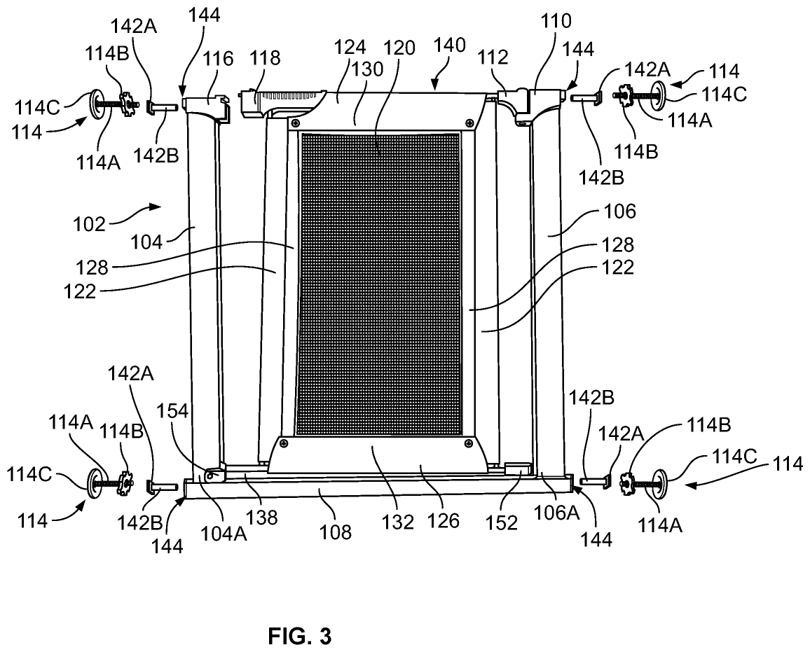

Referring to FIG. 3, the gate 102 is depicted in a partially unassembled state. Prior to installation between the external supports 200, each sleeve 142 is received in a bore 144, depicted in FIG. 4B. Each sleeve 142 includes a flanged end 142A, a sleeve shank 142B, and a passage (not shown) extending through the entire sleeve 142. The flanged end 142A extends away from, and perpendicular to, the elongate direction of the sleeve shank 142B, permitting the length of the sleeve shank 142B to interact with the bore 144. Additionally, the passage may have a uniform diameter extending parallel to the elongate direction of the sleeve shank 142B. The cross-section of each bore 144 may be square, rectangular, triangular, circular, or any other shape, where each sleeve shank 142B may be similarly shaped to be disposed therein. Each threaded member 114 may insert loosely into each sleeve 142. Each threaded member 114 includes a threaded shaft 114A having a washer 114B capable of rotating freely thereon and a pad 114C disposed at one end. The threaded member 114 may be inserted into the sleeve 142 and the sleeve 142 may be inserted into the bore 144. Then, the washer 114C may be rotated along the threaded member 114 in a direction opposite the pad 114B, thereby causing the pad 114B to engage with the external supports 200.

In some embodiments, the gate 102 may be mounted to external supports using fasteners to form a more permanent barrier. Optionally, the threaded members 114 may be replaced with brackets (not shown) capable of attaching to external supports 200 using fasteners, e.g., wood screws, drywall screws, nails, anchors, bolts, and the like. In other embodiments, the threaded members 114 may be inserted into such brackets. In still other embodiments, the gate 102 may be configured to join, hingedly or rigidly, with at least one other gate 102. The junction between multiple gates 102 may be achieved with hinges (not shown) or brackets similar to those used for installation between external supports 200.

Continuing with FIG. 3, the floor support member 108 and second post 106 may be coupled to one another so as to form an angle greater than ninety degrees when free-standing and uninstalled. This obtuse angle causes separation between the upper latch 116 of the first post 104 and the handle 118. During installation or mounting, the extended threaded members 114 exert an amount of pressure sufficient to engage the upper latch 116 of the first post 104 with the handle 118. In this manner, the handle 118 and the upper latch 116 secure the gate door 140 in place, preventing opening.

In some embodiments, both of the posts 104, 106 may join to the floor support 108 to form right angles when uninstalled, eliminating the need for the threaded members 114 to be adjusted between the external supports 200 to exert sufficient pressure for engaging the upper latch 116 with the handle 108. Such an embodiment of the gate 102 may be suitable for use with multiple gates 102 or with brackets capable of fixedly attaching the gate 102 to the external supports 200 using common fasteners, e.g., wood screws, drywall screws, nails, anchors, bolts, and the like.

As seen in FIGS. 4A and 4B, a magnetic mechanism 146 disposed on the handle 118 may be configured to contact a magnetic surface 148 at the first end 116A of the upper latch 116. The magnetic mechanism 146 is attracted to the magnetic surface 148 by magnetic forces, causing the magnetic mechanism 146 to extend towards the magnetic surface 148 when coming within range of the magnetic surface 148, such as by closing the gate door 140.

Continuing with FIG. 4A, the plunger 150, disposed at an end of the lower rod 138 opposite the locator 152, engages with the lower latch 154 when the gate door 140 is in the closed position. The lower latch 154 has a pocket (not shown) positioned vertically along a side engaging with the plunger 150. The pocket has an angled upper end, allowing the plunger 150 to slide into the lower rod 138 in a linear direction parallel to the elongate direction of the lower rod 138. However, the pocket also may include flat sides that prevent the plunger 150 from sliding inwards during lateral movement. In this manner, the plunger 150 only slides inwards upon lifting the gate door 140. Further, the locator 152, attaching the lower rod 138 to the floor support member 108, allows the gate door 140 to rotate, as well as to move upwards to promote the opening process described above. Similarly, the hinge arm 112 attaching the upper rod 136 to the upper hinge shoulder 110, allows the gate door 140 to rotate, as well as to move upwards to promote the opening process described above.

In one aspect, in order to open the gate door 140, the user may pull upwards on the handle 118 after pulling a thumb slide 156 on the handle 118 away from the upper latch 116. This upward pull lifts the entire gate door 140, causing the upper latch 116 to disengage with the handle 118, which separates the magnetic mechanism 146 from the magnetic surface 148. Further, the plunger 150, when lifted upwards, slides inward and disengages with the pocket of the lower latch 154. Accordingly, the gate door 140 may then be rotated clockwise or counterclockwise in relation to the second post 106, as shown in FIG. 4.

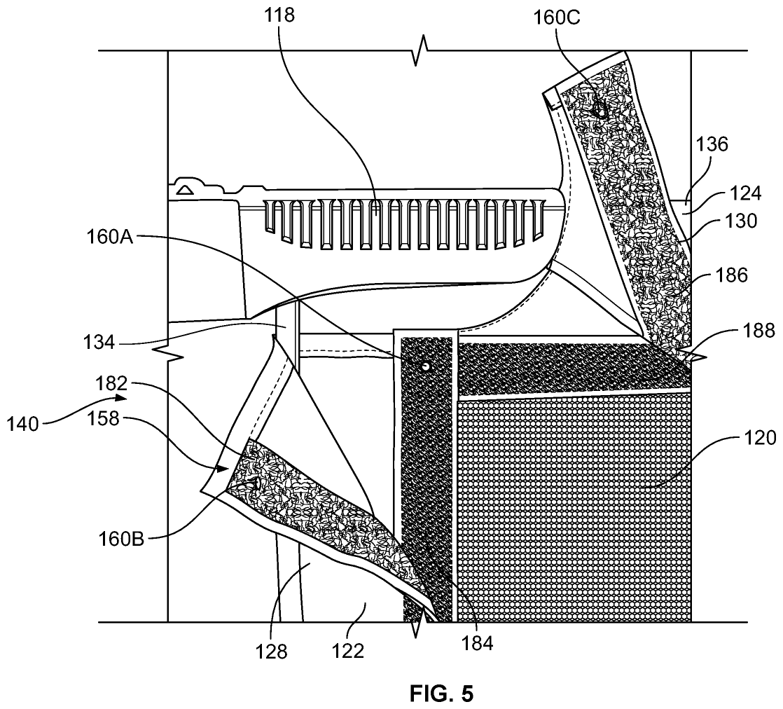

Now referring to FIG. 5, a corner of the gate door 140 is depicted in a partially unassembled state. A vertical rod 134 is shown extending from an underside of the handle 118, while the upper rod 136 extends from a side of the handle 118. A portion of the side panel 122 is peeled away to reveal complementary strips of hook 182 and loop 184 fasteners disposed along inner surfaces of the side panel 122 and its respective flap 128. It is contemplated that the hook 182 and loop 184 fasteners may be substituted with similar fastening means, such as adhesives. Preferably, however, the side panel 122 and flap 128 may be coupled together via releasable means, such as snaps, buttons, or zippers. After the side panel flap 128 is fastened to the side panel 122 using the hook 182 and loop 184 fasteners, or similar means, the upper panel flap 130 may be fastened to the upper panel 124 using another set of hook 186 and loop 188 fasteners, or similar means. Further, a loop fastener patch 158 (not shown), permanently attached to an outer surface of the side panel flap 128, may be configured to receive complementary hook or loop fastener portion of the overlapping upper panel flap 130. Similar hook and loop fastener connections may be used to couple a lower panel flap 132 to the lower panel 126.

With respect to each of the fastenings between each panel and its respective flap, the fasteners may be disposed proximate an innermost periphery of each panel, i.e., proximate an edge of the mesh screen 120, as well as proximate an outermost portion of each respective flap. Additionally, each strip of hook and loop fastener may extend continuously along substantially an entire length of each panel and its respective flap, thereby forming continuous fastening about a periphery of the mesh screen 120.

Staying with FIG. 5, it can be seen that the mesh screen 120 is permanently secured to each of the panels 122, 124. The opposite side panel 122 and lower panel 126 may be secured to the mesh screen 120 in a similar fashion. In particular, FIG. 5 illustrates that the mesh screen 120 is stitched to each of the panels. More specifically, the mesh screen, each panel, and its respective strip of hook and loop fastener may be stitched in a plurality of parallel rows to one another. The stitching may be a chain stitch, a straight stitch, a zigzag stitch, a running stitch, a back stitch, or another kind of stitch that securely joins the mesh screen to the panels.

The gate door 140 additionally may include a plurality of apertures 160 spaced about a periphery of the door. In particular, each aperture 160 may be formed from overlapping first, second, and third apertures 160A, 160B, 160C. The first apertures 160A may be located proximate the corners of the mesh screen 120, e.g., at the intersection of one strip of hook and loop fastener along a first panel with a second strip of hook and loop fastener along an adjacent, second panel, The second apertures 160B may be disposed on the flap associated with the first panel, and the third apertures 160C may be disposed on the flap associated with the adjacent, second panel. The second and third apertures 160B, 160C are positioned on their respective flaps such that, during assembly, the first aperture 160A in the corner is aligned with the aperture 160B, 160C in the side panel flap 128 and the upper panel flap 130 when the flaps are folded over, around their respective rods, and secured to their respective panels. Aligning these apertures 160A-C allows fasteners 162 (discussed below) to be installed in such a way as to secure each layer together, forming a corner of the mesh screen 120. The other corners of the mesh screen 120 are similarly configured.

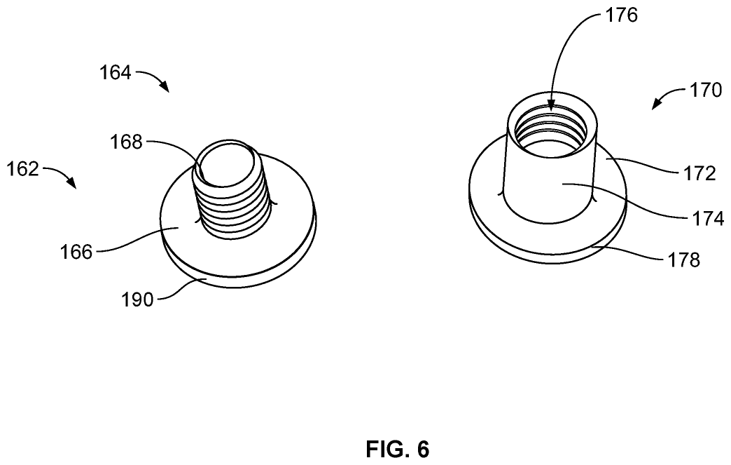

Referring to FIG. 6, the gate 102 may include a plurality of fasteners 162 in addition to the hook and loop fasteners, further securing each panel to its respective flap at each aperture 160. In particular, each fastener 162 may be in the form of a screw socket that includes a screw portion 164 and a socket portion 170. The screw portion 164 of the fastener 162 includes a head 166 having an edge 190 and a threaded shank 168 extending linearly away from the head 166. The socket portion 170 includes a flange 172 having a flange edge 178 and a tube 174 extending away from the flange, the tube 174 having an internal thread bore 176. The thread bore 176 is configured to receive the threaded shank 168 in order to securely couple the screw portion 164 to the socket portion 170. In one aspect, the fastener 162 may be a 3/16″ screw socket, although it will be appreciated that larger or smaller fasteners may be used, provided they are large enough to hold the flaps securely while also being small enough to impede their removal. In particular, the fastener 162 may be configured such that a gap between the head 166 and the flange 172 when the screw portion 164 is inserted fully into the socket portion 170 is no larger than a combined thickness of the panels and flaps through which the shank 168 and tube 174 extend.

In one aspect, the screw portion 164 and socket portion 170 may be composed of metal, such as steel or aluminum or alloys thereof. It is contemplated, however, that other materials suitable for functioning as a fastener may be used, such as plastic or composites. It is contemplated that the head 166 of the screw portion 164 may be circular, or square, or rectangular, or triangular, or even irregularly shaped. Similarly, the flange 172 of the socket portion 170 may be circular, or square, or rectangular, or triangular, or even irregularly shaped.

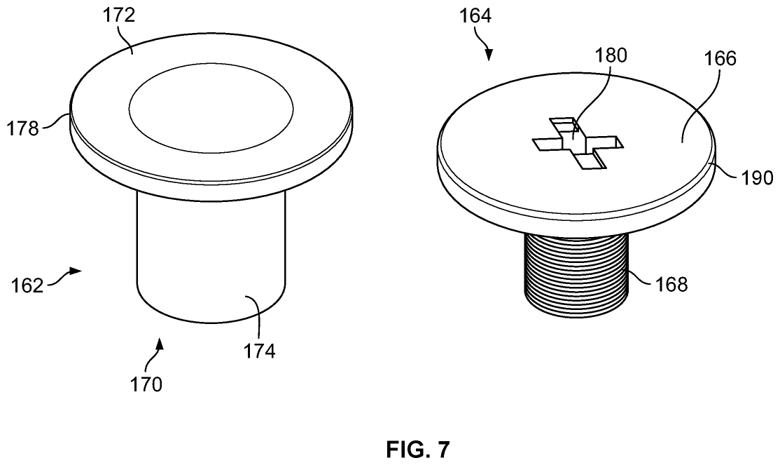

Now referring to FIG. 7, the flange 172 of the socket portion 170 is depicted having a flat, smooth surface. It is contemplated that the flange 172 of the socket portion may have a rough or grooved surface, or a surface having ornamental indicia, or a surface having functional indicia. Further, the flange edges 178 are smooth. However, it is contemplated that the flange edges 178 may be rough or grooved, or may contain ornamental or functional indicia. Similarly the edge 190 on the head 166 may be rough or grooved, or may contain ornamental or functional indicia, rather than being smooth as in the present embodiment. Also, the head 166 is depicted as having a smooth surface with torque transmitting surfaces 180 configured to receive a screwdriver—in this case a Phillips or flat-head screwdriver. However, it is contemplated that the head 166 may include a rough surface having torque transmitting surfaces 180 configured to receive a different tool, such as an Allen wrench, a Torx screwdriver, the edge of a coin, or a fingernail. It may also be contemplated that the threaded shank 168 of the screw portion 164 may interact magnetically with the threaded bore 176 of the socket portion 170.

After each panel is secured to its respective flap, as described above, causing respective sets of apertures 160A, 160B, 160C to be aligned, a screw portion 164 and socket portion 170 may be coupled to one another, through the aligned apertures. The screw portion 164 and socket portion 170 preferably may be tightened beyond a finger-tight amount, thereby preventing removal of the fasteners 162 without an appropriate tool. Additionally, the substantially flat underside surfaces of the head 166 and flange 172, coupled with the comparatively softer fabric from which the panels and flaps are made, may result in the head 166 and flange 172 laying flush or countersunk relative to the panels and flaps, further inhibiting grasping and/or removal of the fasteners 162 without an appropriate tool.

In one aspect, the gate may include four fasteners 162, i.e., one at each corner of the gate. Additional fasteners 162 may be included, e.g., along the length of one or more of the side panels and/or top and bottom panels.

In one aspect, each of the fasteners 162 may be inserted in the same direction, i.e., with all of the screw portions 164 being inserted from one side of the gate 102 and all of the socket portions 170 being inserted from the opposite side. In another aspect, one or more of the fasteners 162 may be inserted in an opposite direction as compared to the remaining fasteners. For example, adjacent fasteners 162 may be inserted in opposite directions from one another. Additionally or alternatively, diagonally opposed fasteners may be inserted in the same direction as one another, which direction may be opposite to the fasteners extending across an opposite diagonal.

The mesh screen 120, upper panel 124, lower panel 126, side panels 122, upper flap 130, lower panel flap 132, and side panel flaps 128 are all formed of fabric capable of being hand-washed or washable in a commercial or residential washing machine. Further, the fabric may be treated with or composed of material that is resistant to fluids commonly found in the house, such as milk, coffee, wine, cooking sauces, and the like. Also, the fabric may be composed of a single color, or may be composed of multiple colors. Additionally, the fabric may have no patterns, or may have ornamental or functional patterns. Still further, the fabric may be composed of material having a scent or fragrance.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the present disclosure and claims. The entire disclosure of each patent and publication cited herein is incorporated by reference, as if each such patent or publication were individually incorporated by reference herein.

We claim:

1. A gate for restricting access to and from an area comprising:
a first post, a second post, a floor support member, a plurality of lateral threaded members, a gate door, and a latch, the gate door further comprising:
a handle, a pair of vertical rods, a pair of horizontal rods, and a mesh screen;
wherein, the mesh screen is removably attached to the vertical rods and the horizontal rods; and,
wherein the gate is configured to be installed between external supports by engaging the plurality of lateral threaded members with the external supports.

2. The gate of claim 1, the mesh screen including at least one flap substantially encasing at least one of the vertical rods or horizontal rods, the at least one flap configured to overlap a respective panel adjacent a mesh portion of the mesh screen.

3. The gate of claim 2, further comprising:
an opening in at least one of the at least one flap and the respective panel; and
a screw socket having a socket portion fixedly coupled to at least one of the at least one flap and the respective panel, the screw socket further comprising a screw portion configured to pass through the opening and to couple to the socket portion.

4. The gate of claim 3, wherein the screw portion is configured to threadingly couple to the socket portion.

5. The gate of claim 3, further comprising a hook and loop fastener connection between the at least one flap and the respective panel.

6. The gate of claim 3, the screw portion including a head,
wherein, when the screw portion is coupled to the socket portion, the head is configured to lay flush or countersunk relative to an outer surface of the at least one flap or the respective panel that defines the opening.

7. The gate of claim 1, wherein the mesh screen is rectangular, the mesh screen including four flaps, each flap substantially encasing a respective one of the vertical or horizontal rods.

8. The gate of claim 7, wherein at least two adjacent flaps include overlapping portions.

9. The gate of claim 8, wherein the overlapping portions define overlapping openings.

10. The gate of claim 9, further comprising a plurality of screw sockets, each screw socket having a socket portion fixedly coupled to one of a flap or a respective panel and a screw portion configured to pass through one of the overlapping openings and to couple to the socket portion.

11. A gate for restricting access to and from an area comprising:
a first post, a second post, a floor support member, and a gate door, the gate door further comprising:
a rigid frame and a mesh screen, the mesh screen including at least one panel adjacent a mesh portion of the mesh screen and at least one flap, the at least one flap substantially encasing a portion of the frame, the at least one flap also configured to overlap the at least one panel;
an opening in at least one of the at least one panel and the at least one flap; and
a screw socket having a socket portion fixedly coupled to at least one of the at least one flap and the overlapping panel, the screw socket further comprising a screw portion configured to pass through the opening and to couple to the socket portion.

12. The gate of claim 11, wherein the screw portion is configured to threadingly couple to the socket portion.

13. The gate of claim 11, further comprising a hook and loop fastener connection between the at least one flap and the overlapping panel.

14. The gate of claim 11, the screw portion including a head,
wherein, when the screw portion is coupled to the socket portion, the head is configured to lay flush or countersunk relative to an outer surface of the at least one flap or the panel that defines the opening.

15. The gate of claim 11, wherein the rigid frame comprises a plurality of vertical rods and a plurality of horizontal rods.

16. The gate of claim 15, wherein the mesh screen is rectangular, the mesh screen including four flaps, each flap substantially encasing a respective one of the vertical or horizontal rods.

17. The gate of claim 16, wherein at least two adjacent flaps include overlapping portions.

18. The gate of claim 17, wherein the overlapping portions define overlapping openings.

19. The gate of claim 18, further comprising a plurality of screw sockets, each screw socket having a socket portion fixedly coupled to one of a flap or a respective panel and a screw portion configured to pass through one of the overlapping openings and to couple to the socket portion.

20. The gate of claim 19, wherein at least one panel and its overlapping flap include mating strips of hook and loop fastener extending substantially all of a distance between adjacent screw sockets.
